(19) United States
(12) Patent Application Publication
(10) Pub. No.: US 2021/0167473 A1
(43) Pub. Date: Jun. 3, 2021

(54) METHOD FOR DISCONNECTING A BATTERY

(71) Applicant: Robert Bosch GmbH, Stuttgart (DE)

(72) Inventors: Joachim Joos, Gerlingen (DE); Johannes Grabowski, Stuttgart (DE); Walter Von Emden, Eningen Unter Achalm (DE)

(21) Appl. No.: 17/267,999

(22) PCT Filed: Sep. 17, 2019
(86) PCT No.: PCT/EP2019/074916

§ 371 Date: Feb. 11, 2021

(30) Foreign Application Priority Data
Sep. 21, 2018 (DE) 10 2018 216 125.9

(51) Int. Cl. H01M 50/574; H01M 10/42

(52) U.S. Cl. CPC H01M 50/574; H01M 2220/20; H01M 2010/4271; H01M 10/425

(57) ABSTRACT

A method for disconnecting a battery including at least two battery cells from at least one electrical component of a vehicle. At least two switching units are associated with each of the battery cells, the battery cells each being electrically connected to the component as a function of the at least two switching units in each case, so that a power supply is established for the component by the battery. The following steps are carried out for the disconnection from the component: a) switching the at least two switching units of a first battery cell of the battery cells, b) switching the at least two switching units of at least a second battery cell of the battery cells.

### FIELD

The present invention relates to a method for disconnecting a battery, in particular a high-voltage battery, including at least two battery cells from at least one electrical component of a vehicle. Moreover, the present invention relates to a device for carrying out the method.

### BACKGROUND INFORMATION

Conventionally, when a vehicle or an electric machine of the vehicle is stopped, the battery of the vehicle is disconnected from the power electronics by a relay. Conventionally, the relay is opened in emergency situations, for example in the event of an accident. Generally, one relay is integrated into a positive “high-side” path, and a further relay is integrated into a negative “low-side” path, the paths denoting the two lines that connect the battery to the electric machine.

German Patent Application No. DE 10 2015 002 069 A1 describes a battery cell for a battery of a motor vehicle. The battery cell may be connected to further battery cells of the battery via two electrical terminals. It is also described that a transport state for the battery may be provided.

A battery system including a battery with a plurality of battery modules is described in German Patent Application No. DE 10 2012 205 395 A1.

German Patent Application No. DE 10 2015 215 797 A1 describes a battery that includes an integrated discharge circuit.

### SUMMARY

The present invention relates to a method for disconnecting a battery, and a device for disconnecting a battery. Further features and details of the present invention result from the description herein, and the figures. Of course, features and details that are described in conjunction with the method according to the present invention also apply in conjunction with the device according to the present invention, and vice versa in each case, and mutual reference is or may always be made to the individual aspects of the present invention.

In particular, in accordance with an example embodiment of the present invention, protection is provided by a method for disconnecting an (in particular rechargeable) battery, preferably a high-voltage battery, including at least two battery cells from at least one electrical component, in particular a drive component, of a vehicle. The disconnection advantageously takes place when the component, in particular the drive component, which is preferably designed as an electric motor or an electric machine (E-machine), is switched off.

The electrical component may be designed as power electronics and/or as an electrical consumer of a vehicle electrical system of the vehicle. In addition, the electrical component may be designed as a high-voltage component and/or as a drive component of the vehicle, such as an electric motor. Similarly, it is possible for the battery to be designed as a rechargeable high-voltage battery for supplying power to the high-voltage component to allow a movement of the vehicle. As an example, the battery is a 400 V or 800 V battery.

In the method according to an example embodiment of the present invention, it is advantageous for the vehicle to be designed as a passenger automobile or truck or the like. The vehicle is advantageously designed as an electric vehicle that includes a hybrid drive or only an electric drive. Similarly, the component may be a component of a high-voltage drive train of an E-machine of the vehicle. In these types of electric vehicles it is thus possible to provide a topology made up of a high-voltage battery pack (i.e., the battery), a DC link, and power electronics of the E-machine.

In a method according to an example embodiment of the present invention, it may be provided that at least two switching units are associated with each of the battery cells of the battery. In other words, for each battery cell, a system including two switching units may be provided and in particular integrated into the battery cell. It is also possible for all battery cells of the battery to include these two switching units, and thus to be disconnectable from the component. This allows a complete disconnection of the battery from the component. Alternatively, in addition to these battery cells including the switching units, other types of battery cells are provided in the battery which cannot be disconnected in the manner described according to the present invention.

According to an example embodiment of the present invention, the battery cells (in particular in each case as a function of the at least two switching units in each case) may be electrically connected to the component via the particular switching units, so that a power supply for the component is provided by the battery. This allows an operation of the component, for example a rotational movement of a drive component and/or a movement of the vehicle. In contrast, by the disconnection from the component, the power supply may be deactivated, and the above-mentioned operation of the component may thus be stopped.

In a method according to an example embodiment of the present invention, the following steps for the disconnection from the component may be carried out, preferably in succession in the indicated order or in an arbitrary order, it also being possible to carry out individual steps repeatedly:
a) switching the at least two switching units of a first of the battery cells,
b) switching the at least two switching units of at least one second (and optionally of a third and fourth, etc.) of the battery cells, in particular gradually, in each case after the preceding switching has occurred, preferably until all switching units of all battery cells have been switched.

In other words, at least two battery cells of the battery may be electrically disconnected from the at least one component via at least two switching units in each case. The switching may involve a closing as well as an opening, the switching units in each case being designed as electronic switching units, for example. Thus, the switching in particular does not relate to a mechanical switching (mechanical opening or closing), but, rather, a switching over from the blocking state into the conducting state and/or vice versa. This allows a reliable and flexible switching of the battery cells. In addition, the use of relays may be avoided. In particular, for relays it is known that spark gaps may result from the mechanical disconnection in the direct voltage line. It is often technically complicated to avoid a defect in the relay (such as sticking) which is thus possible. Furthermore, the use of relays is associated with higher costs. In addition, these disadvantages may be at least reduced by a method according to the present invention.

In a method according to an example embodiment of the present invention and/or a device according to an example embodiment of the present invention, it may be provided to dispense with the relays that generally connect the battery to the component and/or that are integrated into the high-side and/or low-side path. Instead, switching units that are not designed as relays and/or as electronic switching units and/or integrated into the battery cells may be used. The failure rate with respect to the relay may thus be reduced. In addition, installation space may be saved.

The disconnection and/or the carrying out of the described method steps of a method according to the present invention may be initiated, for example, when an electronics system of the vehicle detects a user input for stopping the motor of the vehicle and/or an emergency involving the vehicle.

In a method according to an example embodiment of the present invention, it may be advantageous to gradually carry out the switching of the at least two switching units of at least the second (and optionally further) of the battery cells, in each case after the preceding switching is carried out. In other words, a first of the two switching units (of a certain battery cell) may be initially switched, and a second of the two switching units (of the certain battery cell) is not switched until after a delay time. This switching sequence may optionally be subsequently repeated for further battery cells. The sequential switching of the switching units for each battery cell may thus take place sequentially, battery cell by battery cell. Jumps in voltage and/or current during the disconnection may thus be reduced.

A switching duration for each switching unit and/or the delay time may be, for example, in the range of 1 ns to 100 ns, preferably 10 ns to 50 ns. The switching duration or delay time is preferably less than 100 ns, which for the disconnection may result in a total time period of several 10 μs for the battery. The time period for the disconnection is thus also reduced in comparison to the relay. An improved and controlled secure state may thus be generated.

According to one advantageous refinement of the present invention, it may be provided that step b) is carried out only after step a), and in particular each further gradual switching after the preceding switching is not carried out until a switch-on condition is present, the gradual switching preferably taking place in each case as a function of time and/or current, preferably as a function of an electric current detection in the current path of the switching unit utilized for the preceding switching. Thus, for example, the switching according to step b) may also take place as a function of an electric current detection in the current path of the switching unit utilized for the switching according to step a). The switch-on condition may preferably be the current intensity exceeding, falling below, or reaching a predetermined current intensity, which is detected in particular after the switching in the current path in the switching unit utilized for this switching.

Furthermore, within the scope of the present invention, it is possible that for switching the at least two switching units of the first and/or second and/or at least one further of the battery cells, in each case the two switching units are sequentially switched after a delay time. The delay time may be predefined, for example, by electronics of the battery cell (in particular by an appropriate activation of the switching units by the electronics). Such electronics are, for example, integrated into each of the battery cells of the battery.

In addition, it may be possible for the at least two switching units in each case to be designed as at least one coupling switching unit and one short-circuit switching unit, the coupling switching unit preferably being integrated into a current path of the particular battery cell (in series with same), and the short-circuit switching unit being integrated into a current path in parallel to the particular battery cell, these switching units preferably being sequentially switchable for the disconnection. All battery cells or switching units of the battery cells may be designed according to this arrangement. To disconnect one of the battery cells from the component, the short-circuit switching unit of this battery cell may initially be closed, and the coupling switching unit of this battery cell may be opened only afterwards (after a delay time, for example). This operation may be repeated for the further battery cells for the complete (electrical) disconnection of the battery.

In a method according to an example embodiment of the present invention, the disconnection may be understood to mean that the disconnection takes place not in the sense of a physical separation of the electrical connection, but rather, takes place electrically in such a way that an electric current flow is blocked by electronic switches (such as transistors or field effect transistors). Similarly, the switching units may be such electronic switches, preferably power switches.

In addition, it is optionally possible that for the particular disconnection of the battery cells, the short-circuit switching unit of the particular battery cell is initially switched, in particular closed, and after a delay time the coupling switching unit is switched, in particular opened. A reliable disconnection of the battery cells is thus possible. This switching pattern may be sequentially repeated for further battery cells.

In a further option, it may be provided that for disconnecting further battery cells, they are gradually disconnected from the at least one component, at least 5 or at least 10 or at least 20 battery cells being disconnected in succession. The voltage or the electric current delivered to the component by the battery may be gradually reduced in this way.

Furthermore, it is advantageous when, within the scope of the present invention, the battery is designed as a high-voltage battery, for example a 400 V (volt) or 800 V battery. Alternatively or additionally, the switching units may be integrated into the battery. This allows a very space-saving design.

Moreover, the present invention relates to a device for disconnecting a battery including at least two battery cells from at least one electrical component of a vehicle. In accordance with an example embodiment of the present invention, It is provided that the device is designed to carry out a method according to the present invention. The device according to the present invention thus yields the same advantages as those described in detail with regard to a method according to the present invention.

Further advantages, features, and particulars of the present invention result from the following description in which exemplary embodiments of the present invention are described in greater detail with reference to the figures. The features mentioned in the description may in each case be important to the present invention, alone or in any arbitrary combination.

### BRIEF DESCRIPTION OF THE DRAWINGS

FIG. 1 shows a schematic representation for illustrating a method according to an example embodiment of the present invention.

FIG. 2 shows a schematic representation of a device according to the present invention for illustrating a method according to an example embodiment of the present invention.

FIG. 3 shows a schematic representation of a sequence of a method according to an example embodiment of the present invention.

### DETAILED DESCRIPTION OF EXAMPLE EMBODIMENTS

In the figures, identical reference numerals are used for the same technical features, even of different exemplary embodiments.

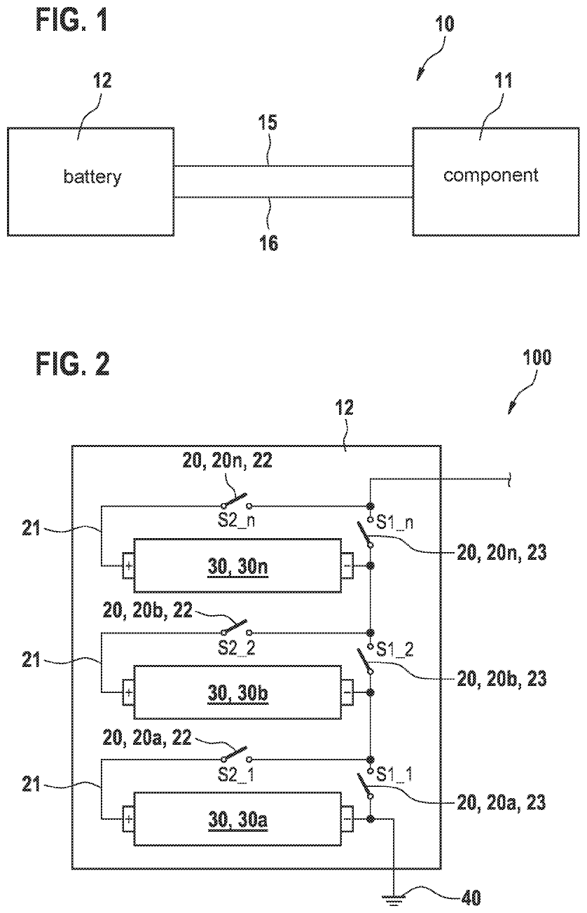

A method according to an example embodiment of the present invention is schematically illustrated with reference to FIGS. 1 through 3, it being possible in particular for component 11 to be a drive component 11 of a vehicle 10. This component is supplied with power by a battery 12, in particular a high-voltage battery 12, and thus operated. For this purpose, battery 12 may be connected to component 11 via two current paths 15, 16 (high-side 15 and low-side 16).

FIG. 2 shows a device 100 according to an example embodiment of the present invention for carrying out a method according to the present invention in greater detail.

At least two battery cells 30a, 30b of battery 12 may be electrically connected to the at least one component 11, and thus switched on, via at least two switching units 20a, 20b in each case.

It is apparent that at least two switching units 21 are associated with each of battery cells 30, battery cells 30 in each case being electrically connected to component 11 as a function of the at least two switching units 21 in each case, so that a power supply for component 11 is provided by battery 12.

Battery 12 may include a first battery cell 30a, a second battery cell 30b, and optionally further battery cells 30 up to an nth battery cell 30n. Each of these battery cells 30 may be associated with at least two or exactly two switching units 20. Similarly, at least two first switching units 20a may be associated with first battery cell 30a, at least two second switching units 20b may be associated with second battery cell 30b, and at least two nth switching units 20n may be associated with nth battery cell 30n (n is an arbitrary integer). The at least two switching units 20 for each battery cell 30 may also be subdivided into a coupling switching unit 22 and a short-circuit switching unit 23. Coupling switching unit 22 is integrated, for example, into the same current path 21 as that of associated battery cell 30. Short-circuit switching unit 23 together with further short-circuit switching units 23 is integrated, for example, into a current path that leads from the DC link of the vehicle or from component 11 to a ground potential 40. Coupling units 22 may connect associated battery cell 30 to component 11, whereas short-circuit switching units 23 may bridge battery cells 30 associated with the component.

FIG. 2 is to be understood only in a representative sense, so that even further battery cells 30 may be provided and gradually added and/or disconnected, it being possible only by way of example for at least 5 or at least 10 or at least 20 battery cells 30 to be added in succession and/or subsequently again disconnected. In particular, the at least one particular switching unit 20 may include at least one coupling switching unit 22 and one short-circuit switching unit 23 that is associated with the particular battery cell 30, and that may be reciprocally switched over to add and/or disconnect this battery cell 30.

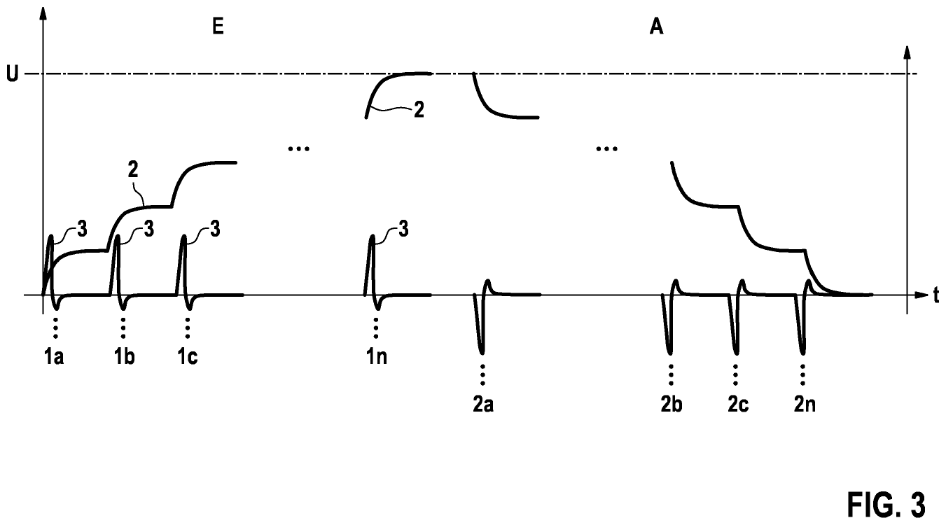

According to FIG. 3, a gradual adding and subsequently a gradual disconnection are initially illustrated for better understanding of the present invention. An example of a profile of a voltage 2 and of an electric current 3 in the current path between battery 12 and component 11 is shown as a function of time t.

The addition or the disconnection may take place in each case only when a switch-on condition for the preceding addition or disconnection is present. For this purpose, the gradual addition or disconnection may each be carried out as a function of an electric current detection in the current path of switching unit 20 that is utilized for this addition or disconnection.

The addition may take place, for example, until a total voltage U is reached by a voltage 2 of battery 12.

For a first addition 1a, initially switching unit S2_n (shown in FIG. 2) may be closed and S1_n may be opened. A time period may then be awaited until current 3 has died down (i.e., remains at 0 ampere). The maximum current intensity of current 3 is limited in this way. This may be carried out in a time-controlled or current-controlled manner, for example, by electronics in battery 12. For a second addition 1b, switching unit S2_2 may be subsequently closed and switching unit S1_2 may be opened. Likewise, after the presence of the switch-on condition, i.e., in particular the time period, a third addition 1c may take place. The addition may be carried out multiple times for further battery cells 30, up to an nth addition in which a switching unit S2_1 is closed and a switching unit S1_1 is opened. The switching units, which are associated with a shared battery cell 30, may optionally be reciprocally opened. When all switches S1_1 through S1_n are opened and correspondingly all switches S2_1 through S2_n are closed, the full DC link voltage is present and the power electronics may start E-motor 11 or component 11.

To subsequently allow a disconnection of battery 12 from component 11 in order to stop E-motor 11 and/or in the event of an emergency, according to a method according to the present invention a switching of the at least two switching units 21 of a first battery cell 30a of battery cells 30 may initially take place, and then a switching of the least two switching units 21 of at least one second battery cell 30b of battery cells 30 may take place. The switching may also be carried out for further battery cells 30, so that a first disconnection 2a of first battery cell 30a initially takes place in that switching unit S1_1 is closed, and after a delay time switching unit S2_1 is opened. Switching unit S1_2 may subsequently be closed and S2_2 may be opened in order to carry out a second disconnection 2b for second battery cell 30b of battery cells 30. A third disconnection 2c may similarly be carried out for a further battery cell 30. Lastly, an nth disconnection may be effectuated by closing switching unit S1_n and opening switching unit S2_n (in particular after the delay time). In particular, the disconnection of battery cells 30 is thus carried out in the reverse order as for the addition.

The above explanation of the specific embodiments describes the present invention solely in terms of examples. Of course, individual features of the specific embodiments, if technically feasible, may be freely combined with one another without departing from the scope of the present invention.

1-10. (canceled)

11. A method for disconnecting a battery including at least two battery cells from at least one electrical component of a vehicle, at least two respective switching units being associated with each of the battery cells, each of the battery cells each being electrically connected to the component as a function of the at least respective two switching units in each case, so that a power supply is established for the component by the battery, the method comprising the following steps:
a) switching the at least respective two switching units of a first battery cell of the battery cells; and
b) switching the at least two respective switching units of at least a second battery cell of the battery cells.

12. The method as recited in claim 11, wherein the switching of the at least two respective switching units of at least the second battery cell of the battery cells is carried out gradually, in each case after a preceding switching has occurred.

13. The method as recited in claim 11, wherein step b) is carried out only after step a), each further gradual switching after the preceding switching is not carried out until a switch-on condition is present, the gradual switching taking place in each case as a function of time and/or current.

14. The method as recited in claim 11, wherein step b) is carried out only after step a), each further gradual switching after the preceding switching is not carried out until a switch-on condition is present, the gradual switching taking place in each case as a function of an electric current detection in a current path of a switching unit utilized for the preceding switching.

15. The method as recited in claim 11, wherein for switching the at least two switching units of the first battery cell and/or second battery cell and/or at least one further of the battery cells, in each case the two respective switching units are sequentially switched after a delay time.

16. The method as recited in claim 11, wherein the at least two respective switching units of each battery cell of the battery cells are configured as at least one respective coupling switching unit and one short-circuit respective switching unit, the coupling switching unit being integrated into a current path of the battery cell, and the short-circuit switching unit being integrated into a current path in parallel to the battery cell, the respective switching units being sequentially switched for the disconnection.

17. The method as recited in claim 16, wherein for the disconnection of each battery cell of the battery cells, the respective short-circuit switching unit of the battery cell is initially switched closed, and after a delay time, the respective coupling switching unit is switched open.

18. The method as recited in claim 11, wherein for disconnecting further battery cells of the battery, the further battery cells are gradually disconnected from the at least one component, at least 5 battery cells being disconnected in succession.

19. The method as recited in claim 11, wherein for disconnecting further battery cells of the battery, the further battery cells are gradually disconnected from the at least one component, at least 10 battery cells being disconnected in succession.

20. The method as recited in claim 11, wherein for disconnecting further battery cells of the battery, the further battery cells are gradually disconnected from the at least one component, at least 20 battery cells being disconnected in succession.

21. The method as recited in claim 11, wherein the battery is a high-voltage battery.

22. The method as recited in claim 11, wherein the respective switching units are integrated into the battery.

23. A device for disconnecting a battery including at least two battery cells from at least one electrical component of a vehicle, at least two respective switching units being associated with each of the battery cells, each of the battery cells each being electrically connected to the component as a function of the at least respective two switching units in each case, so that a power supply is established for the component by the battery, the device being configured to:
a) switch the at least respective two switching units of a first battery cell of the battery cells; and
b) switch the at least two respective switching units of at least a second battery cell of the battery cells.
